(19) United States
(12) Patent Application Publication
(10) Pub. No.: US 2004/0163751 A1
(43) Pub. Date: Aug. 26, 2004

(54) Method of and apparatus for affixing backing to plates

(76) Inventor: Richard Taffinder, West Midlands (GB)

Correspondence Address: Clifford W Browning, Woodard Emhardt Naughton Moriarty & McNett, Bank One Center/Tower Suite 3700, 111 Monument Circle, Indianapolis, IN, 46204-5137, US

(21) Appl. No.: 10/480,628

(22) PCT Filed: Jun. 18, 2002
(86) PCT No.: PCT/GB02/02761

(30) Foreign Application Priority Data
Jun. 18, 2001 (GB) 0114834.5

(51) Int. Cl. B32B 31/00; B60R 13/10

(52) U.S. Cl. 156/64; 156/250; 156/350; 156/353

(57) ABSTRACT

A method of affixing backing (20) to plates (30) involves the use of apparatus (10) forming part of a continuous production line (40) for the manufacture of vehicle registration number plates (50). An elongate of web the backing (20) is advanced through the apparatus (10). The web of backing (20) is comprised of a series of web lengths marked out thereon by transverse lines (65) of perforations. The method includes halting advancement of the web of backing (20) when a perforated line (65) is adjacent an advanceable and retractable blade (135), such that a leading edge of the plate (30) is aligned with the line perforated (65) of the web of backing (20). The blade (135) is then retracted and the plate (30) and the web of backing (20) are advanced together so as to present a web length in face-to-face contact with, and so as to be bonded to, the plate (30). The plate (30), together with the web length bonded thereto, is then separated from the web of backing (20) by tearing the web of backing (20) along the perforated lines (65) thereof that coincide with the ends of the plate (30).

This invention relates to a method of and apparatus for affixing backing to plates. More particularly, it relates to affixing reflective material with alphanumeric characters printed thereon to plates of transparent material so as to produce vehicle registration number plates.

A known method of producing vehicle registration number plates involves the use of a continuous web of backing which is punched to weaken the backing along lines on either side of a vehicle registration number that is depicted or is to be depicted on the backing. The lines of weakening are such that the area that they encompass corresponds to the profile of a transparent plate to which that portion of the backing is then bonded. The transparent plate can then be separated from the remainder of the backing by tearing the backing along the lines of weakening.

The known method requires a gap of about 5 mm between the weakening line at the rear of the area of backing around a first number depicted on the backing and the weakening line at the front of the area of backing around the next number depicted on the backing. However, this 5 mm gap of unused backing between each adjacent pairs of areas of backing results in a significant waste of backing during extended production runs.

It is an object of this invention to address this problem.

According to one aspect of this invention there is provided a method for

affixing backing to plates including the steps of:

a) providing an elongate web of backing that includes reference marks thereon arranged so as to mark out web lengths on the elongate web, at least one web length corresponding to the length of a respective one of the plates;

b) advancing the elongate web of backing;

c) sensing when a first one of the reference marks is adjacent abutment means and advancing one of the plates into abutment with the abutment means, whereby a leading edge of the plate is substantially aligned with the first reference mark;

d) advancing the plate and the elongate web together so as to maintain the substantial alignment of the leading edge and the first reference mark and so that the plate is presented face-to-face with a respective web length of corresponding length, a trailing edge of the plate being in substantial alignment with a second one of the reference marks;

e) bonding the plate to the respective web length; and

f) breaking the elongate web along one or both of the first and second reference marks so as to separate the plate and the respective web length bonded thereto from the elongate web,

including advancing the abutment means into a position in which it can be abutted by the plate in step (c) and retracting the abutment means thereafter such that step (d) can take place.

Advancing and retracting the abutment means in this way is advantageous in enabling accurate alignment of edges of the plate with the reference marks that serve as edges of the respective web length that is to be bonded thereto. A further advantage is that gaps between adjacent web lengths on the web can be minimised and may be eliminated such that the trailing edge of a first web length is the leading edge of a second web length, thereby minimising waste material of the web,

Step (c) may include the step of slowing the advancement of the elongate web as the first reference mark approaches the abutment means. Advancement of the elongate web may be suspended when the first reference mark is adjacent the abutment means and while the plate is advanced into abutment with the abutment means.

Step (c) may include sensing one or more of the reference marks other than the first reference mark, to thereby ascertain the position of the first reference mark relative to the abutment means.

The step of bonding the plate to the respective web length may be concurrent with the step of presenting the plate to the respective web length. The plate and/or the elongate web may include an adhesive. Preferably the elongate web includes an adhesive on the surface thereof that is presented to the plate. The elongate web may have an adhesive strip adhering to that surface in a face-to-face fashion to create a laminate. Preferably the laminate is such that removal of the adhesive strip from the elongate web exposes adhesive deposited on that surface of the elongate web by the adhesive strip.

Preferably the method is repeated with successive web lengths being affixed to successive plates. Each plate, together with the respective web length affixed thereto, may not be separated from the elongate web until after a subsequent plate has been aligned with or presented to a subsequent web length.

According to another aspect of this invention there is provided apparatus for affixing backing to plates, the apparatus including plate advancement means, web advancement means and sensing means, the web advancement means being operable to advance an elongate web of backing that includes reference marks thereon that mark out web lengths on the elongate web, wherein the sensing means is operable to sense when a first one of the reference marks is adjacent abutment means, and the plate advancement means is operable to advance one of the plates into abutment with the abutment means whereby a leading edge of the plate is substantially aligned with the first reference mark, the plate advancement means and the web advancement means being further operable to advance the plate and the elongate web together so as to maintain substantial alignment of the leading edge and the first reference mark and so that the plate is presented face-to-face with a web length, a trailing edge of the plate being substantially in alignment with a second one of the reference marks, the abutment means being advanceable into a position in which it can be abutted by the plate, and being retractable into a position in which the plate and the elongate web can be advanced together.

The sensing means may be arranged such that when the second reference mark is adjacent the sensing means, the first reference mark is adjacent the abutment means. Preferably the sensing means is operable to sense that the second reference mark is adjacent to it and to produce an output signal indicative of this. Preferably the apparatus is responsive to the output signal to advance the plate into abutment with the abutment means.

The apparatus may include processing and control means operable to calculate when the first reference mark is approaching the abutment means and to slow the advancement of the elongate web accordingly. The processing and control means may subsequently stop the advancement of the elongate web in response to the signal from the sensing means, thereby accurately stopping the first reference mark adjacent the abutment means.

Preferably the apparatus is arranged to present successive plates face-to-face with respective, successive web lengths.

The apparatus may include alignment means through which the elongate web and/or the or each plate is or are advanced. Preferably the alignment means is arranged such that, during operation, it constrains movement of the elongate web and/or the or each plate in directions other than the direction of advancement of the elongate web through the alignment means. The alignment means may include nip rollers to constrain movement of the elongate web and/or the or each plate perpendicular to the plane of the elongate web. The rollers may be driven so as to form part of the web advancement means and/or the plate advancement means.

The alignment means may include the abutment means. The abutment means may include an advanceable and retractable member, such as a blade or edge, the advanceable and retractable member being advanceable into a position in which it can be abutted by the or each plate, and retractable from the advanced position such the plate and the elongate web can be advanced together.

Preferably the marks are lines of weakening that extend substantially transverse the length of the elongate web and that facilitate breaking of the elongate web therealong. The lines of weakening may be lines of perforations through the backing that result in a substantially clean break in a substantially straight line.

The reference marks may include a substantially v-shaped cut-out from material of the elongate web adjacent each end of each line of weakening, such that each web length is a rectangle with a radius at each corner. Preferably, the profile of each web length is substantially the same as that of each plate 30.

Preferably each web length is arranged to be presented to a respective plate. Preferably the plates and web lengths have substantially the same length and width. Conveniently, each web length may be slightly longer, for example 0.25 mm longer, than each plate. This is advantageous in providing a small gap between successive plates to facilitate the breaking of the or each plates and web lengths affixed thereto from the elongate web. Preferably the or each plate and web length affixed thereto is separated from the elongate web by rotation of the plate and web length affixed thereto relative to the elongate web in the plane of the plate, thereby breaking the elongate web along the reference mark adjacent the trailing edge of the plate that is rotated. Step (f) may include the operation of plate rotation means to separate the plate and web length affixed thereto from the elongate web in this way. The apparatus may include the plate rotation means.

The elongate web may also include one or more alphanumeric characters. The characters may be printed on one of both surfaces of the elongate web. In a first embodiment, the characters may be printed on the surface of the elongate web that is presented to the or each plate. The or each plate may be transparent and preferably is clear such that the characters are viewable therethrough. The or each plate may be acrylic.

In an alternative embodiment, the characters may be printed on the surface of the elongate web that is not presented to the or each plate. The surface on which the characters are printed may be provided with a coating, subsequent to printing the characters, for protecting the characters printed thereon. The or each plate may be opaque and may be made of a metal such as aluminium.

Preferably the or each surface on which the characters are printed is reflective. Preferably one or more web lengths include characters arranged to make up a vehicle registration number. Preferably the or each plate with a web length affixed thereto is a vehicle registration number plate.

According to a further aspect of this invention there is provided an elongate web of backing adapted for use in the method and/or with the apparatus.

According to a still further aspect of this invention there is provided a method for affixing backing to plates including the steps of:

a) providing an elongate web of backing that includes reference marks thereon arranged so as to mark out web lengths on the elongate web, at least one web length corresponding to the length of a respective one of the plates;

b) advancing the elongate web of backing;

c) sensing when a first one of the reference marks is adjacent abutment means and advancing one of the plates into abutment with the abutment means, whereby a leading edge of the plate is substantially aligned with the first reference mark;

d) advancing the plate and the elongate web together so as to maintain the substantial alignment of the leading edge and the first reference mark and so that the plate is presented face-to-face with a respective web length of corresponding length, a trailing edge of the plate being in substantial alignment with a second one of the reference marks;

e) bonding the plate to the respective web length; and

f) breaking the elongate web along one or both of the first and second reference marks so as to separate the plate and the respective web length bonded thereto from the elongate web,

including the step of sensing when the second reference mark is adjacent the abutment means and advancing a second plate into abutment therewith so as to substantially align a leading edge of the second plate with the second reference mark.

According to yet further aspect of this invention there is provided apparatus for affixing backing to plates, the apparatus including plate advancement means, web advancement means and sensing means, the web advancement means being operable to advance an elongate web of backing that includes reference marks thereon that mark out web lengths on the elongate web, wherein the sensing means is operable to sense when a first one of the reference marks is adjacent abutment means, and the plate advancement means is operable to advance one of the plates into abutment with the abutment means whereby a leading edge of the plate is substantially aligned with the first reference mark, the plate advancement means and the web advancement means being further operable to advance the plate and the elongate web together so as to maintain substantial alignment of the leading edge and the first reference mark and so that the plate is presented face-to-face with a web length, a trailing edge of the plate being substantially in alignment with a second one of the reference marks, the apparatus being arranged to sense when the second reference mark is adjacent the abutment means and to advance a second plate into abutment therewith so as to substantially align a leading edge of the second plate with the second reference mark.

The abutment means of the still and/or yet further aspects of this invention may include an advanceable and retractable member.

Advancement of each plate into abutment with the abutment means may be preceded by the step of advancing the advanceable and retractable member into a position in which it can be abutted by the plate.

Advancement of each plate into abutment with the abutment means may be followed by the step of retracting the advanceable and retractable member from the advanced position such that the respective plate and the elongate web can be advanced together.

The abutment means of the still further and/or yet further aspects may be the trailing edge of a previous plate that has been presented to a respective web length.

Optional features of the first, the other and the further aspects of this invention may also be optional features of the still further and the yet further aspects of this invention.

A specific embodiment of this invention is now described by way of example only and with reference to the accompanying drawings, in which:

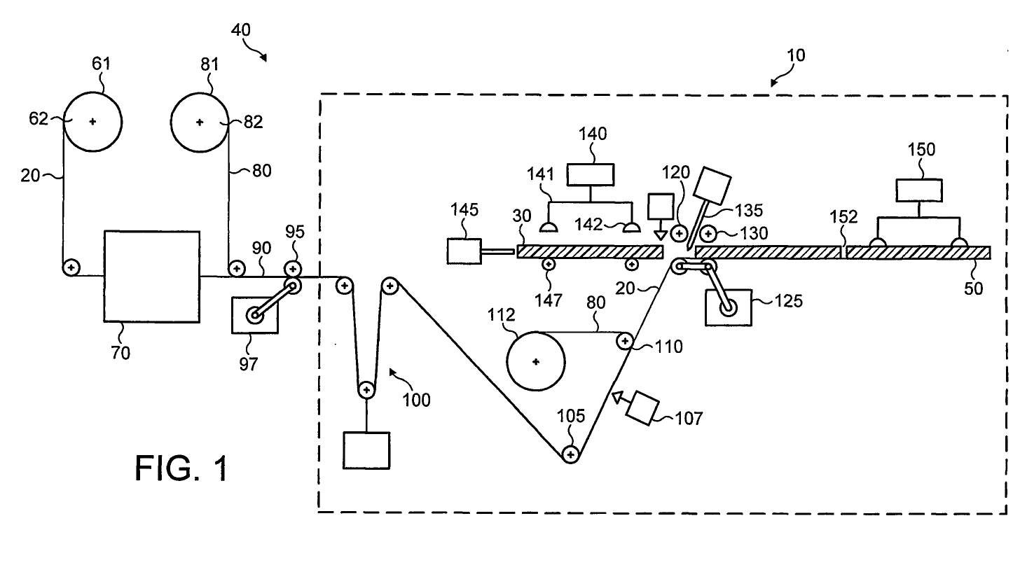

FIG. 1 shows a general assembly of a production line for manufacturing vehicle registration number plates;

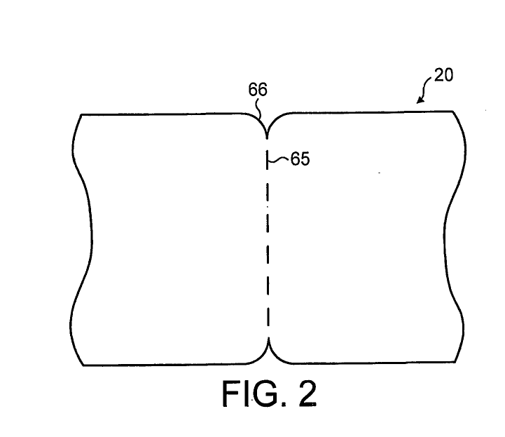

FIG. 2 shows a plan view of part of an elongate web of backing; and

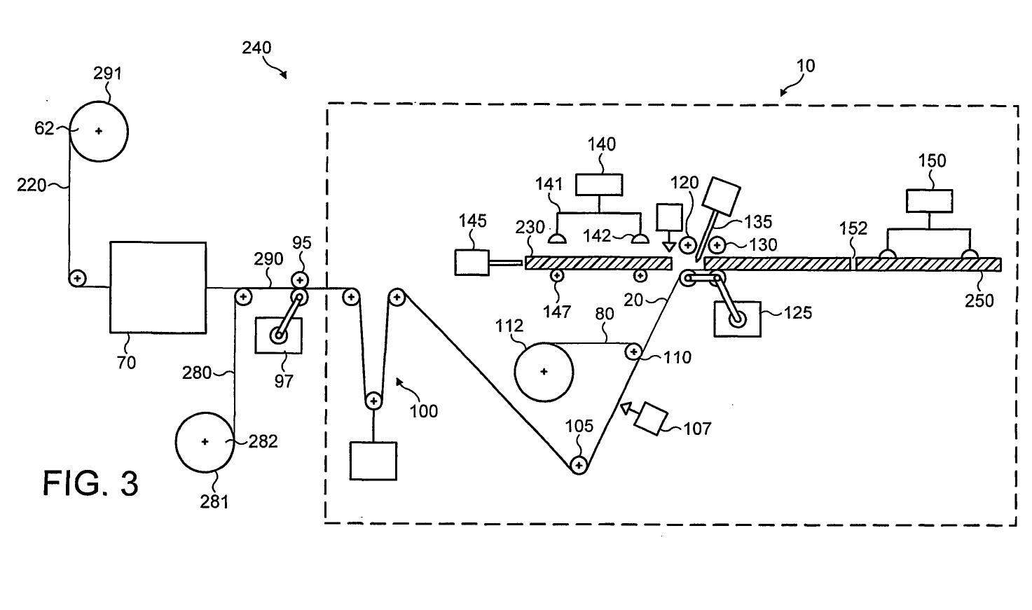

FIG. 3 shown a general assembly of another production line for manufacturing vehicle registration number plates.

FIG. 1 shows apparatus 10 for affixing backing 20 to plates 30. The apparatus 10 forms part of a continuous production line 40 for manufacturing vehicle registration number plates 50.

Each plate 30 is a substantially rectangular plate of transparent material such as acrylic. The corners of each plate are slightly rounded and the profile of each plate is that of a vehicle registration number plate 50.

An elongate web of backing 20 extends through components of the production line 40 and of the apparatus 10. The backing is a thin, flexible film having a reflective surface and a non-reflective surface. A stock of the backing in the form of a large wound-up roll 61 is held on a backing mandrel 62. The backing mandrel 62 is rotatably mounted.

The backing 20 that makes up the roll 61 is pre-punched at regular intervals along its length. As shown in FIG. 2, the pre-punching takes the form of perforated lines 65 cut into the backing and extending substantially at right angles to its length. The interval between each line is slightly more, for example 0.25 mm more, that the length of each of the plates 30. The reason for this will be described below. The pre-punching also has the effect of removing a v-shaped portion of material from the backing 20 in the region of each end of each line 65. As a result, the area of the backing 20 between adjacent lines is a rectangle with a radius 66 at each corner. The profile of each such area is substantially the same as that of each plate 30.

The elongate web of backing 20 extends from an outermost layer of the roll 61 to an inlet side of a printer 70 through which the backing 20 passes. The printer 70 is operable to print a vehicle registration number on the reflective surface of the backing 20, between adjacent lines 65.

A wound-up roll 81 of adhesive strip 80 is also provided. The roll 81 of adhesive strip 80 is held on an adhesive strip mandrel 82. The adhesive strip 80 extends from an outermost layer of the roll 81 to the reflective surface of the elongate web of backing 20 with which the adhesive strip 80 is in face-to-face adhesive contact. The point at which the adhesive strip comes into contact with the elongate web 20 is adjacent an outlet side of the printer 70. Together, the elongate web 20 and the strip of adhesive 80 form a laminate 90. The laminate 90 passes generally horizontally between a first pair of nip rollers 95 that contact the laminate. The nip rollers 95 are arranged for rotation by a first stepper motor 97.

From the first pair of nip rollers 95, the laminate 90 passes through a counter balanced floating roller arrangement 100. Such arrangements are known to those skilled in the art and will not be described further.

From the floating roller arrangement 100, the laminate 90 extends generally downwards, around a lower roller 105 and generally upwards to a separation roller 110. In passing from the lower roller 105 to the separation roller 110, the laminate 90 passes between light emitting and light receiving portions of sensing means in the form of an optical sensor 107. At the separation roller 110 the adhesive strip 80 is separated from the backing 20 and is wound around a rewind mandrel 112. The mandrel 112 is rotatably mounted and arranged for rotation by a second stepper motor (not shown). Separation of the adhesive strip 80 from the backing 20 results in adhesive (not shown) being deposited on the reflective surface of the backing 20.

From the separation roller 112 the elongate web of backing 20, with the adhesive thereon, extends generally upwards and through alignment means. The alignment means includes a second and a third pair of nip rollers 120,130 respectively. The second and third pair of nip rollers 120,130 are arranged for rotation by a third stepper motor 125. The non-reflective surface, which is lowermost, passes over a lower roller of each pair 120,130 in a generally horizontal direction.

The alignment means also includes abutment means in the form of a blade 135 and an actuator (not shown). The blade 135 is mounted on an extendable and retractable actuator arm of the actuator so as to be advanceable and retractable thereby. It is envisaged that the actuator may be any type of known actuator, such as a pneumatic, hydraulic or servo-electric actuator. In an advanced position, the blade 135 projects generally downwards, in-between the second nip rollers 120 and the third nip rollers 130 such that a leading edge of the blade 135 almost contacts the lower roller of the second pair of nip rollers 120. The alignment means has an inlet side adjacent the second pair of nip rollers 120 and an outlet side adjacent the third pair of nip rollers 130.

The apparatus 10 includes plate advancement means positioned on the inlet side of the alignment means. The plate advancement means includes a first plate pick-and-place device 140 and a plate pusher 145. The first plate pick-and-place device 140 is a moveable arm 141 that has two suckers 142 thereon. The suckers are operable to releasably attach themselves to ones of the plates 30. The plate pusher 145 is another known actuator that has an extendable and retractable arm.

The apparatus 10 also includes plate rotation means in the form of a second plate pick-and-place device 150 positioned on the outlet side of the alignment means. The second plate pick-and-place device 150 is similar to the first plate pick-and-place device 140.

In operation, the first stepper motor 97 is operated such that the first pair of nip-rollers 95 rotate and pull the laminate 90 therethrough. This causes the elongate web of backing 20 to be pulled through the printer 70 and the roll of backing 61 to unwind. The printer 70 prints selected alphanumeric characters on the reflective surface of the backing to create vehicle registration numbers thereon. Each number is printed on a length of the elongate web of backing 20 between a respective pair of adjacent lines of weakening 65. The movement of the laminate 90 through the first nip rollers 95 also causes the roll of adhesive strip 81 to unwind. The first stepper motor may remain at a substantially constant speed during operation.

The second stepper motor (not shown) is also operated so as to cause the rewind mandrel 112 to rotate, pulling the adhesive strip 80 around the separation roller 110 and from contact with the elongate web of backing 20. It will be appreciate that this also causes the laminate 90 to be advanced from the lower roller 105 in the direction of the separation roller 110. Preferably the speed of the second stepper motor is such that the speed of advancement of the laminate over the lower roller 105 is higher than that on the other side of the floating pulley 100. This causes the floating pulley 100 to operate and to “give out” lengths of the laminate 90.

The third stepper motor 125 is also operated so as to cause the second and third pairs of nip rollers 120,130 to rotate and draw the elongate web of backing 20 therethrough. The speed of the third stepper motor 125 is such that the elongate web of backing 20 remains taught between the separation roller 110 and the second pair of nip rollers 120.

The first pick-and-place device 140 is operated to pick a first plate 30 from a stack of plates (not shown) and place it on plate-support rollers 147 so as to lie substantially horizontally in between the plate pusher 145 and the inlet side of the alignment means.

The second and third stepper motors 125 are operated as described above until the sensor 107 detects a radius 66 adjacent thereto, at which time the second and third stepper motors 125 are slowed or stopped. When the second and third stepper motors 125 are stopped the floating roller 100 operates to “take up” the laminate 90 emerging from the first nip rollers 95 and to keep the laminate 90 taught.

The position of the sensor 107 is such that when a radius is adjacent the sensor 107, a first line of weakening 65 is in a predetermined position, adjacent the lower roller of the second pair of nip rollers 120. Simultaneously, the blade 135 is advanced so that the leading edge thereof is adjacent the first line of weakening 65 that is in the predetermined position. The plate pusher 145 is then activated to advance the first plate 30 towards and the blade 135. The plate 30 is advanced in this way until a leading edge of the first plate 30 abuts the leading edge of the blade 135. In this position, the leading edge of the first plate 30 is aligned with the first line of weakening 65 that is in the predetermined position.

The blade 135 is then retracted and the blade pusher 145 and the second and third stepper motors 125 are operated such that the elongate web of backing 20 and the first plate 30 advance through the second and third nip rollers 120,130 together and so that the alignment between the leading edge of the plate 30 and the first line of weakening 65 is preserved. The speed of operation of the second and third stepper motors 125 is as described before such that the floating roller 100 gives out lengths of laminated previously taken up.

Advancement of the first plate 30 and the elongated web of backing 20 through the second and third nip rollers 120,130 together causes the upper, reflective, surface of the backing 20 that includes the adhesive to be presented to an underside of the first plate 30. The adhesive causes the first plate 30 and the elongate web of backing 20 to be bonded face-to-face. Advancement through the second and third pairs of nip rollers 120,130 reinforces this bonding, the rollers exerting a compressive force on the first plate 30 and backing 20.

Advancement of the first plate 30 and the backing 20 continues until another radius is sensed by the sensor 107. This causes the second and third stepper motors to be slowed or stopped as described previously. It will be appreciated that a second line of weakening 65 is now in the predetermined position. Furthermore, as the distance between successive ones of the lines 65 is substantially the same as the length of each plate, the second line is substantially aligned with a trailing edge of the first plate 30. The blade 135 is then advanced and a second plate 30, having been previously placed on the rollers 147, is advanced into abutment with the blade 135 as described previously. Again, the abutment is such that a leading edge of the second plate 30 is substantially aligned with the second one of the lines. The second plate 30 and the elongate web of backing 30 are then advanced together through the second and third nip rollers 120, 130 as described previously with reference to the first plate 30.

In this preferred embodiment, the distance between successive lines of weakening 65 is greater than the length of each plate 30 by a small amount (a fraction of a millimetre or perhaps a few millimetres). The arrangement of the apparatus 10 is such that successive plates are separated by this small amount, with each line of weakening 65 preferably falling substantially midway between a trailing edge of one plate 30 and a leading edge of a subsequent plate 30. There is therefore a gap 152 between the trailing edge of the first plate 30 and the leading edge of the second plate 30.

The second plate pick-and-place device 150 is then operated to attach itself to an upper surface of the first plate 30 and rotate that plate 30 relative to the second plate 30 in a generally horizontal plane. This causes the elongate web of backing 20 to tear along the second line of weakening 65. The first plate 30, together with the backing 20 affixed thereto is thereby separated from the remainder of the elongate web of backing 20. The small gap is advantageous in facilitating a clean tear. If the first plate 30 is the first plate of a production run to emerge from the apparatus 10, backing 20 projecting from the leading edge of the plate may be removed by hand. It will be appreciated that for all subsequent plates 30, this would not be necessary.

The apparatus 10 is operated repeatedly in this manner to affix backing 20 to successive plates 30, thereby manufacturing vehicle registration number plates.

In an alternative embodiment, the apparatus 10 may not include the blade 135. Instead, the abutment means may be provided by the trailing edge of a previous plate 30. It will be appreciated that this alternative embodiment would not tend to result in small gap between successive plates 30 and that the distance between successive lines of weakening 65 should be reduced by the aforementioned small amount accordingly.

Although not shown in the drawings, it is envisaged that the apparatus to may include processing and control means, such as a microprocessor. The microprocessor may control the remainder of the apparatus 10 in accordance with a programme stored in the microprocessor. The microprocessor may be operable to calculate the approximate position of ones of the lines of weakening 65. From this, the microprocessor may anticipate when ones of the lines 65 approach the predetermined positioned and slow the second and third stepper motors 125 accordingly, thereby slowing the advancement of the elongate web of backing 20. This calculation may be achieved by counting the number of “steps” taken by one or more of the stepper motors 97,125. Slowing the elongate web of backing 20 in this way is advantageous in allowing the sensor 107 to more accurately sense the position of radii 66 adjacent thereto. This in turn results in a more accurate positioning of successive lines 65 in the predetermined position and more accurate alignment of the leading and trailing edge of each plate 30 with respective ones of the lines 65.

FIG. 3 shows an alternative embodiment in which the apparatus 10 is used for affixing the backing 20 to alternative plates 230. The apparatus 10 forms part of another continuous production line 240 for manufacturing alternative vehicle registration number plates 250. It is envisaged that this other continuous production line 240 is suitable for manufacturing vehicle registration number plates of the type used in the United States of America.

Each alternative plate 230 is a substantially rectangular plate, with slightly rounded corners such that the profile of each plate is that of the alternative vehicle registration number plate 250 that is to be manufactured. Each alternative plate 250 may be plastic or metal and may also be opaque.

Another laminate 290, similar to the previously-described laminate 90, is substituted for the backing 20 at the start of the other production line 240. The other laminate 290 differs from the previously described laminate 90 in that the strip of adhesive 80 is applied to the non-reflective surface of the backing 20. The other laminate 290 is provided in a wound-up roll 291 on the backing mandrel 62. The pre-applied adhesive strip 80 may or may not include lines of weakening that correspond to those 65 of the backing 20.

The other laminate 290 extends from an outer surface of the roll 291 thereof to the inlet side of the printer 70. However, the orientation of the other laminate 290 is such that the reflective surface of the backing 20 faces downwards. The printer 70 is inverted in this embodiment, with respect to the first embodiment, so that it is operable to print on the reflective surface.

Upon leaving the printer 70, the laminate 290 is not presented with an adhesive strip 80 from an adhesive strip mandrel 82 as in the first embodiment: the laminate 290 already includes such a strip 80. The adhesive strip mandrel 82 is therefore not present in this embodiment. However, the laminate 290 is presented with a strip of protective coating 280. A stock of the strip of protective coating 280 in the form of a large wound-up roll 281 is held on a coating mandrel 282. The coating mandrel 282 is positioned below the other laminate 290 and a length of the strip of protective coating 280 extends from the roll 281 thereof to the downward-facing reflective surface of the other laminate 290, with which it is in face-to-face contact. The strip of protective coating 280 is for protecting that which is printed on the reflective surface of the other laminate 290 by the printer 70.

The rest of the continuous production line 240 is as before. In particular, the rewind mandrel 112 operates to separate the strip of adhesive 80 from the other laminate 290. Removal of the strip exposes adhesive (not shown) deposited on the elongate web of backing 20, but deposited on the non-reflective side, rather than on the reflective side as in the first embodiment. The backing 20 is then aligned with and presented to the alternative plates 230 in the same way that it is aligned with and present to the plates 30 in the first embodiment. The alternative plates 230, together with the respective length of backing 20 bonded there to, are separated from the remainder of the elongate web of backing 20 as previously described to give the alternative vehicle registration number plates 250.

It will be appreciated that in this alternative embodiment the vehicle registration number is printed on the surface of the backing 20 that is not bonded to the alternative plate 230, and that this is the surface that is to be viewed. In this respect, the backing 20 may, more accurately, be considered as “facing” in the alternative embodiment.

In another embodiment that is also not shown, the elongate web may be of transparent material with alphanumeric characters printed on the surface thereof that is for presenting to the or each plate. The alphanumeric characters are printed for viewing through the transparent material. The transparent material is preferably polyester with a thickness of between 50 and 150 microns. The plates need not be of transparent material and are preferably of ABS plastic. The surface of each plate that is for presenting to the transparent material is preferably laminated, or otherwise coated, with reflective material prior to use of the plates in the method or apparatus of this other embodiment. Again, in this other embodiment, the elongate web may be considered as “facing”.

1. A method for affixing backing to plates including the steps of:
a) providing an elongate web of backing that includes reference marks thereon arranged so as to mark out web lengths on the elongate web, at least one web length corresponding to the length of a respective one of the plates;
b) advancing the elongate web of backing;
c) sensing when a first one of the reference marks is adjacent abutment means and advancing one of the plates into abutment with the abutment means, whereby a leading edge of the plate is substantially aligned with the first reference mark;
d) advancing the plate and the elongate web together so as to maintain the substantial alignment of the leading edge and the first reference mark and so that the plate is presented face-to-face with a respective web length of corresponding length, a trailing edge of the plate being in substantial alignment with a second one of the reference marks;
e) bonding the plate to the respective web length; and
f) breaking the elongate web along one or both of the first and second reference marks so as to separate the plate and the respective web length bonded thereto from the elongate web,
characterised by advancing the abutment means into a position in which it can be abutted by the plate in step (c) and retracting the abutment means thereafter such that step (d) can take place.

2. A method according to any one of the preceding claims, wherein step (c) includes the step of slowing the advancement of the elongate web as the first reference mark approaches the abutment means.

3. A method according to claim 2 wherein advancement of the elongate web is suspended when the first reference mark is adjacent the abutment means and while the plate is advanced into abutment with the abutment means.

4. A method according to any one of the preceding claims, wherein step (c) includes sensing one or more of the reference marks other than the first reference mark, to thereby ascertain the position of the first reference mark relative to the abutment means.

5. A method according to any one of the preceding claims, wherein the step of bonding the plate to the respective web length is concurrent with the step of presenting the plate to the respective web length.

6. A method according to any one of the preceding claims, including the further step of sensing when the second reference mark is adjacent the abutment means and advancing a second plate into abutment therewith so as to substantially align a leading edge of the second plate with the second reference mark.

7. A method according any one of the preceding claims, wherein the method is repeated with successive web lengths being affixed to successive plates.

8. A method according to claim 7, wherein each plate, together with the respective web length affixed thereto, is separated from the elongate web after a subsequent plate has been aligned with or presented to a subsequent web length.

9. A method according to any one of the preceding claims, wherein step (f) includes the operation of plate rotation means to rotate the plate and the web length affixed thereto relative to the elongate web in the plane of the plate, thereby breaking the elongate web along the reference mark adjacent the trailing edge of the plate that is rotated and to, separate the plate and web length affixed thereto from the elongate web.

10. Apparatus for affixing backing to plates, the apparatus including plate advancement means, web advancement means and sensing means, the web advancement means being operable to advance an elongate web of backing that includes reference marks thereon that mark out web lengths on the elongate web, wherein the sensing means is operable to sense when a first one of the reference marks is adjacent abutment means, and the plate advancement means is operable to advance one of the plates into abutment with the abutment means whereby a leading edge of the plate is substantially aligned with the first reference mark, the plate advancement means and the web advancement means being further operable to advance the plate and the elongate web together so as to maintain substantial alignment of the leading edge and the first reference mark and so that the plate is presented face-to-face with a web length, a trailing edge of the plate being substantially in alignment with a second one of the reference marks,
characterised by the abutment means being advanceable into a position in which it can be abutted by the plate, and being retractable into a position in which the plate and the elongate web can be advanced together.

11. Apparatus according to claim 10, wherein the abutment means includes an advanceable and retractable member.

12. Apparatus according claim 10 or claim 11, wherein the sensing means is arranged such that when the second reference mark is adjacent the sensing means, the first reference mark is adjacent the abutment means.

13. Apparatus according to claim 12, wherein the sensing means is operable to sense that the second reference mark is adjacent to it and to produce an output signal indicative of this.

14. Apparatus according to claim 13, wherein the apparatus is responsive to the output signal to advance the plate into abutment with the abutment means.

15. Apparatus according to any one of claim 10 to claim 14, wherein the apparatus includes processing and control means operable to calculate when the first reference mark is approaching the abutment means and to slow the advancement of the elongate web accordingly.

16. Apparatus according to claim 15, wherein the processing and control means is arranged to subsequently stop the advancement of the elongate web in response to the signal from the sensing means, thereby accurately stopping the first reference mark adjacent the abutment means.

17. Apparatus according to any one of claim 10 to claim 16, wherein the apparatus is arranged to sense when the second reference mark is adjacent the abutment means and to advance a second plate into abutment therewith so as to substantially align a leading edge of the second plate with the second reference mark.

18. Apparatus according to any one of claim 10 to claim 17, wherein the apparatus is arranged to present successive plates face-to-face with respective, successive web lengths.

19. Apparatus according to any one of claims 10 to 18, wherein the apparatus includes alignment means through which the elongate web and/or the or each plate is or are advanced.

20. Apparatus according to claim 19, wherein the alignment means is arranged such that, during operation, it constrains movement of the elongate web and/or the or each plate in directions other than the direction of advancement of the elongate web through the alignment means.

21. Apparatus according to claim 19 or claim 20, wherein the alignment means includes nip rollers to constrain movement of the elongate web and/or the or each plate perpendicular to the plane of the elongate web.

22. Apparatus according to claim 21, wherein the rollers are driven so as to form at least part of the web advancement means and/or the plate advancement means.

23. Apparatus according to any one of claims 10 to 22, wherein the marks are lines of weakening that extend substantially transverse the length of the elongate web and that facilitate breaking of the elongate web therealong.

24. Apparatus according to claim 23, wherein the lines of weakening are lines of perforations through the backing that result in a substantially clean break in a substantially straight line.

25. Apparatus according to claim 23 or claim 24, wherein the reference marks includes a substantially v-shaped cut-out from material of the elongate web adjacent each end of each line of weakening, such that each web length is a rectangle with a radius at each corner.

26. Apparatus according to any one of claims 10 to 25, wherein each web length is arranged to be presented to a respective plate.

27. Apparatus according to any one of claims 10 to 26, wherein the profile of each web length is substantially the same as that of each plate.

28. Apparatus according to claim 27, wherein each web length is slightly longer than each plate.

29. Apparatus according to claim 28, wherein each web length is 0.25 mm longer than each plate.

30. Apparatus according to any one of claims 10 to 29, wherein the apparatus includes plate rotation means and the or each plate and the respective web length affixed thereto is separated from the elongate web by rotation of the plate and web length affixed thereto relative to the elongate web in the plane of the plate by operation of the plate rotation means, thereby breaking the elongate web along the reference mark adjacent the trailing edge of the plate that is rotated.

31. A method according to any one of claim 1 to claim 9, or apparatus according to any one of claim 10 to claim 30, wherein the or each plate with a web length affixed thereto is a vehicle registration number plate.

32. An elongate web of backing adapted for use in a method according to any one of claims 1 to 9 or 31, or for use in the apparatus of any one of claims 10 to 31.
